(19) United States
(12) Patent Application Publication
(10) Pub. No.: US 2025/0171088 A1
(43) Pub. Date: May 29, 2025

(54) VEHICLE

(71) Applicant: BYD COMPANY LIMITED, SHENZHEN (CN)

(72) Inventors: Junfei YAN, Shenzhen (CN); Baoguang ZHAO, Shenzhen (CN); Tengyong LIU, Shenzhen (CN); Hai HUANG, Shenzhen (CN); Yanli ZHAO, Shenzhen (CN)

(21) Appl. No.: 19/037,903

(22) Filed: Jan. 27, 2025

Related U.S. Application Data
(63) Continuation of application No. PCT/CN2023/109873, filed on Jul. 28, 2023.

(30) Foreign Application Priority Data
Jul. 29, 2022 (CN) 202210911282.5

(51) Int. Cl. B62D 25/14; B60K 1/04; B62D 25/20

(52) U.S. Cl. CPC B62D 25/145; B60K 1/04; B62D 25/2036; B60K 2001/0438

(57) ABSTRACT

A vehicle includes: a left front longitudinal beam and a right front longitudinal beam spaced apart in a width direction of the vehicle; a left A-pillar and a right A-pillar spaced apart in the width direction, the left front longitudinal beam connected with a lower section of the left A-pillar, and the right front longitudinal beam connected with a lower section of the right A-pillar; a windshield upper cross beam having two ends respectively connected with an upper section of the left A-pillar and an upper section of the right A-pillar; and a battery pack having a front end connected to the left front longitudinal beam and the right front longitudinal beam. The left front longitudinal beam, the right front longitudinal beam, the left A-pillar, the right A-pillar, the windshield upper cross beam, and the battery pack form a first A-pillar annular force transmission structure.

### CROSS-REFERENCE TO RELATED APPLICATIONS

This application is a continuation application of International Patent Application No. PCT/CN2023/109873, filed on Jul. 28, 2023, which is based on and claims priority to and benefits of Chinese Patent Application No. 202210911282.5, filed on Jul. 29, 2022. The entire content of all of the above-referenced applications is incorporated herein by reference.

### FIELD

The present disclosure relates to the technical field of electric vehicles, and more particularly, to a vehicle.

### BACKGROUND

To protect a battery pack of an electric vehicle, the battery pack is usually arranged on a vehicle bottom. In the related art, the battery pack is connected to a vehicle body assembly on two sides in a width direction of the vehicle body assembly through connection points arranged on two sides. However, the battery pack is connected to the vehicle body assembly only in the width direction of the vehicle body assembly, causing the battery pack to be unable to effectively improve torsional performance of the vehicle body.

### SUMMARY

The present disclosure resolves one of technical problems in the related art at least to some extent.

The present disclosure provides a vehicle.

The vehicle according to the present disclosure includes a left front longitudinal beam, a right front longitudinal beam, a left A-pillar, a right A-pillar, a windshield upper cross beam, and a battery pack. The left front longitudinal beam and the right front longitudinal beam are spaced apart in a width direction of the vehicle. The left A-pillar and the right A-pillar are spaced apart in the width direction of the vehicle. The left front longitudinal beam is connected with a lower section of the left A-pillar. The right front longitudinal beam is connected with a lower section of the right A-pillar. Two ends of the windshield upper cross beam are respectively connected with an upper section of the left A-pillar and an upper section of the right A-pillar. A front end of the battery pack is directly connected to the left front longitudinal beam and the right front longitudinal beam. The left front longitudinal beam, the right front longitudinal beam, the left A-pillar, the right A-pillar, the windshield upper cross beam, and the battery pack form a first A-pillar annular force transmission structure.

Additional aspects and advantages of the present disclosure is provided in the following description, which become apparent from the following description, or are learned through practice of the present disclosure.

### BRIEF DESCRIPTION OF THE DRAWINGS

FIG. 1 is a bottom view of a vehicle without a battery pack being mounted according to an embodiment of the present disclosure;

FIG. 2 is a bottom view of a vehicle with a battery pack being mounted to a vehicle bottom according to an embodiment of the present disclosure;

FIG. 3 is an exploded view of a vehicle according to an embodiment of the present disclosure;

FIG. 4 is a schematic diagram of an A-pillar of a vehicle according to an embodiment of the present disclosure;

FIG. 5 is a schematic diagram of a rear floor of a vehicle according to an embodiment of the present disclosure;

FIG. 6 is a schematic diagram of a tail end of a vehicle according to an embodiment of the present disclosure; and

FIG. 7 is a schematic diagram of a tail end of a vehicle with a middle floor being removed according to an embodiment of the present disclosure.

### DETAILED DESCRIPTION

Embodiments of the present disclosure are described in detail below. Examples of the embodiments are shown in accompany drawings. Same or similar elements or elements having same or similar functions are denoted by same or similar reference numerals throughout the description. The embodiments described below with reference to the accompanying drawings are examples to explain the present disclosure, and should not be construed as a limitation on the present disclosure.

In the description of the present disclosure, it should be understood that orientation or position relationships indicated by the terms such as “center”, “longitudinal”, “transverse”, “length”, “width”, “upper”, “lower”, “front”, “rear”, “left”, “right”, “vertical”, “horizontal”, “top”, “bottom”, “inner”, “outer”, and “circumferential direction” are based on orientation or position relationships shown in the accompanying drawings, and are used only for ease and brevity of illustration and description, rather than indicating or implying that the mentioned apparatus or component must have a particular orientation or must be constructed and operated in a particular orientation. Therefore, such terms should not be construed as a limitation on the present disclosure.

In the present disclosure, unless otherwise explicitly specified or defined, the terms such as “mount”, “connected”, “connection”, and “fix” should be understood in a broad sense. For example, the connection may be a fixed connection, a detachable connection, or an integral connection; or the connection may be a mechanical connection or an electrical connection; or the connection may be a direct connection, an indirect connection through an intermediate medium, internal communication between two elements, or an interaction relationship between two elements. A person of ordinary skill in the art may understand the meanings of the foregoing terms in the present disclosure according to situations.

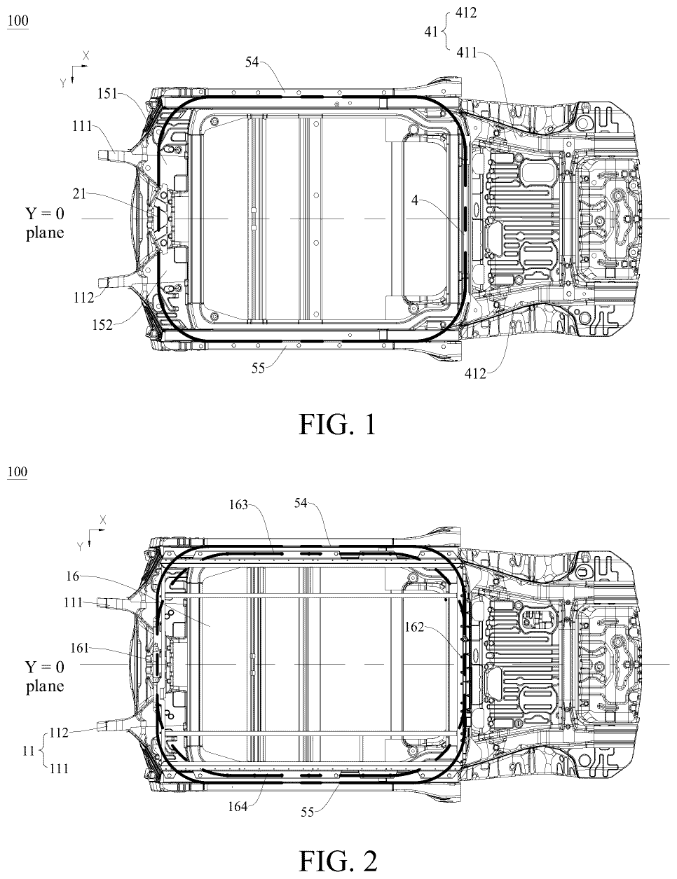

A vehicle 100 in the embodiments of the present disclosure is described below with reference to FIG. 1 to FIG. 7.

Referring to FIG. 1, FIG. 2, and FIG. 4, the embodiments of the present disclosure provide the vehicle 100. The vehicle includes a left front longitudinal beam 111, a right front longitudinal beam 112, a left A-pillar 131, a right A-pillar 132, a windshield upper cross beam 14, and a battery pack 16. The left front longitudinal beam 111 and the right front longitudinal beam 112 are arranged/disposed spaced apart in a width direction of the vehicle 100. The left A-pillar 131 and the right A-pillar 132 are arranged spaced apart in the width direction of the vehicle 100. The left front longitudinal beam 111 is connected with a lower section of the left A-pillar 131. The right front longitudinal beam 112 is connected with a lower section of the right A-pillar 132. Two ends of the windshield upper cross beam 14 are respectively connected with an upper section of the left A-pillar 131 and an upper section of the right A-pillar 132. A front end 161 of the battery pack is directly connected to the left front longitudinal beam 111 and the right front longitudinal beam 112. The left front longitudinal beam 111, the right front longitudinal beam 112, the left A-pillar 131, the right A-pillar 132, the windshield upper cross beam 14, and the battery pack 16 form a first A-pillar annular force transmission structure 1.

Referring to FIG. 1, FIG. 2, and FIG. 4, the vehicle 100 in the embodiments of the present disclosure includes a left front longitudinal beam 111, a right front longitudinal beam 112, a left A-pillar 131, a right A-pillar 132, a windshield upper cross beam 14, and a battery pack 16. The left A-pillar 131 and the right A-pillar 132 are arranged spaced apart in a width direction of the vehicle 100. Two ends of the windshield upper cross beam 14 are respectively connected with an upper section of the left A-pillar 131 and an upper section of the right A-pillar 132, thereby connecting the left A-pillar 131 and the right A-pillar 132 together at the upper sections thereof. The left front longitudinal beam 111 and the right front longitudinal beam 112 are arranged spaced apart in the width direction of the vehicle 100. The front end 161 of the battery pack is directly connected to the left front longitudinal beam 111 and the right front longitudinal beam 112, thereby connecting the left front longitudinal beam 111 and the right front longitudinal beam 112 together in the width direction of the vehicle 100. The left front longitudinal beam 111 is connected with a lower section of the left A-pillar 131. A rear section of the right longitudinal beam is connected with a lower section of the right A-pillar 132, thereby connecting the left A-pillar 131 and the right A-pillar 132 at the lower sections thereof. In this case, the left front longitudinal beam 111, the battery pack 16, the right front longitudinal beam 112, the right A-pillar 132, the windshield upper cross beam 14, and the left A-pillar 131 form a first A-pillar annular force transmission structure 1. Since the battery pack 16 has relatively great strength and stiffness, the battery pack 16 is used as a part of the first A-pillar annular force transmission structure 1, which can effectively enhance the strength of the first A-pillar annular force transmission structure 1, improve the torsional resistance, and improve the torsional strength of the vehicle 100.

In this way, in the vehicle 100 according to the embodiments of the present disclosure, the front end 161 of the battery pack is directly connected to the left front longitudinal beam 111 and the right front longitudinal beam 112, to cause the left front longitudinal beam 111, the battery pack 16, the right front longitudinal beam 112, the right A-pillar 132, the windshield upper cross beam 14, and the left A-pillar 131 to form the first A-pillar annular force transmission structure 1. Through the first A-pillar annular force transmission structure 1, the torsional strength of the vehicle 100 can be improved.

Compared with the prior art, the battery pack 16 is only provided with connection points on two sides of the vehicle 100 in the width direction, and is not connected to an A-pillar 13 at the front end of the vehicle 100. In the present disclosure, the front end 161 of the battery pack 16 is directly connected to the left front longitudinal beam 111 and the right front longitudinal beam 112, thereby forming the first A-pillar annular force transmission structure 1 with the left front longitudinal beam 111, the right front longitudinal beam 112, the right A-pillar 132, the windshield upper cross beam 14, and the left A-pillar 131, which can effectively enhance the strength of the first A-pillar annular force transmission structure 1, improve the torsional resistance, and improve the torsional strength of the vehicle 100.

In some embodiments of the present disclosure, referring to FIG. 1 and FIG. 4, the vehicle 100 further includes a dash board lower cross beam 21. The dash board lower cross beam 21 is arranged between the left front longitudinal beam 111 and the right front longitudinal beam 112, and is connected with the left front longitudinal beam 111 and the right front longitudinal beam 112. The left front longitudinal beam 111, the right front longitudinal beam 112, the left A-pillar 131, the right A-pillar 132, the windshield upper cross beam 14, and the dash board lower cross beam 21 form a second A-pillar annular force transmission structure 2. The second A-pillar annular force transmission structure 2 is combined with the first A-pillar annular force transmission structure 1 to improve the torsional strength of the vehicle 100.

In some embodiments of the present disclosure, referring to FIG. 2, a projection of the battery pack 16 in an up-down direction of the vehicle 100 at least partially overlaps with a projection of the dash board lower cross beam 21 in the up-down direction of the vehicle 100, so that the battery pack 16 and the dash board lower cross beam 21 at least partially form a superimposed double-layer structure in a height direction of the vehicle 100, which can improve the strength of the first A-pillar annular force transmission structure 1, improve the torsion resistance, and improve the torsional strength of the vehicle 100.

In some embodiments, referring to FIG. 2, the projection of the dash board lower cross beam 21 in the up-down direction of the vehicle 100 completely falls within the projection of the battery pack 16 in the up-down direction of the vehicle 100.

In some embodiments of the present disclosure, referring to FIG. 4, the front end 161 of the battery pack is directly connected to the dash board lower cross beam 21. The front end 161 of the battery pack is directly connected to the dash board lower cross beam 21, so that the first A-pillar annular force transmission structure 1 and the second A-pillar annular force transmission structure 2 are connected together, thereby enhancing the strength of the first A-pillar annular force transmission structure 1, and improving the torsional resistance of the vehicle 100.

In some embodiments of the present disclosure, referring to FIG. 1, the left front longitudinal beam 111 includes a rear section 151. The right front longitudinal beam 112 includes a rear section 152. The rear section 151 of the left front longitudinal beam is connected with the left A-pillar 131 and the dash board lower cross beam 21. The rear section 152 of the right front longitudinal beam is connected with the right A-pillar 132 and the dash board lower cross beam 21.

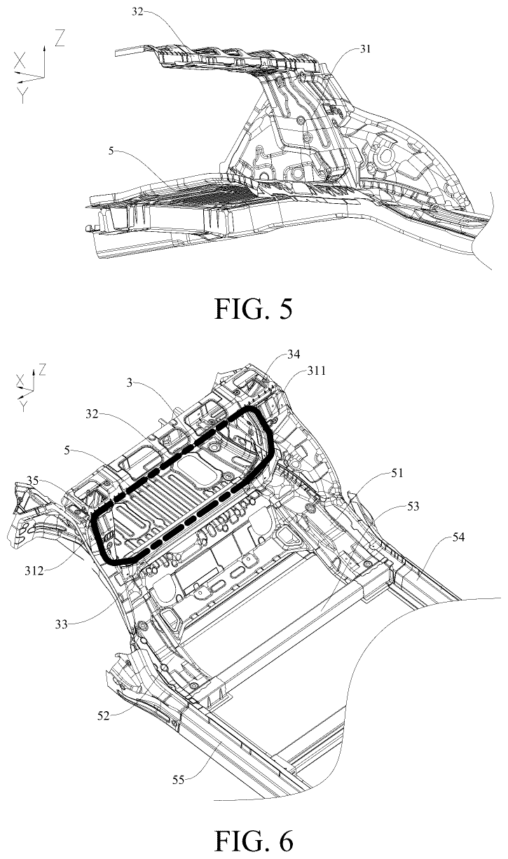

In some embodiments of the present disclosure, referring to FIG. 5 and FIG. 6, the vehicle 100 further includes a rear floor upper cross beam 33, a left shelf support plate 311, a right shelf support plate 312, and a shelf connecting plate 32. The left shelf support plate 311 and the right shelf support plate 312 are arranged spaced apart in a width direction of the vehicle 100. Two ends of the rear floor upper cross beam 33 are respectively connected with a lower section of the left shelf support plate 311 and a lower section of the right shelf support plate 312. Two ends of the shelf connecting plate 32 are respectively connected with an upper section of the left shelf support plate 311 and an upper section of the right shelf support plate 312. The rear floor upper cross beam 33, the left shelf support plate 311, the right shelf support plate 312, and the shelf connecting plate 32 form a first C-pillar annular structure 3.

The left shelf support plate 311 and the right shelf support plate 312 are connected by the shelf connecting plate 32 at the upper sections of the shelf connecting plate, and are connected by the rear floor upper cross beam 33 at the lower sections of the rear floor upper cross beam. In this way, the left shelf support plate 311, the shelf connecting plate 32, the rear floor upper cross beam 33, and the right shelf support plate 312 form the first C-pillar annular structure 3, which improves the structural strength of the vehicle 100 at a C-pillar.

The rear floor upper cross beam 33 is arranged at a front end of the rear floor 5. Left and right ends of the rear floor 5 are connected with an inner wheel housing panel. First joints are respectively connected with two ends of the rear floor upper cross beam 33. The two ends of the rear floor upper cross beam 33 are respectively connected to the left shelf support plate 311 and the right shelf support plate 312 through the first joints. The left shelf support plate 311 includes a left shelf front support plate and a left shelf rear support plate. On a left side of the rear floor upper cross beam 33, upper ends of the first joints are connected with a lower end of the left shelf front support plate and a lower end of the left shelf rear support plate respectively. An upper end of the left shelf front support plate and an upper end of the left shelf rear support plate are connected with one end of the shelf connecting plate 32. On a right side of the rear floor upper cross beam 33, the upper ends of the first joint are connected with a lower end of a right shelf front support plate and a lower end of a right shelf rear support plate respectively. An upper end of the right shelf front support plate and an upper end of the right shelf rear support plate are connected with another end of the shelf connecting plate 32.

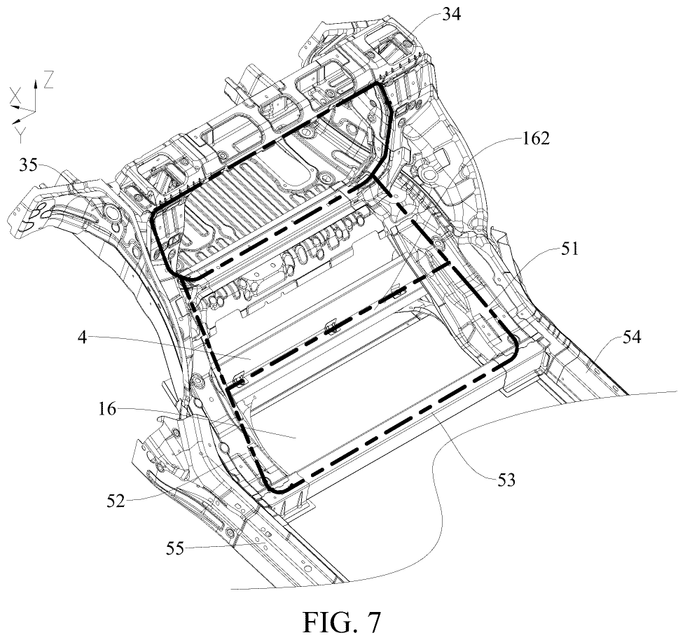

In some embodiments of the present disclosure, referring to FIG. 6 and FIG. 7, the vehicle 100 further includes a left C-pillar 34 and a right C-pillar 35. The left shelf support plate 311 is connected with the left C-pillar 34. The right shelf support plate 312 is connected with the right C-pillar 35. The first C-pillar annular structure 3 is connected to the left C-pillar 34 and the right C-pillar 35 respectively through the left shelf support plate 311 and the right shelf support plate 312, which can further effectively enhance the torsional stiffness of the vehicle 100 and improve the torsional resistance while enhancing the strength of the first C-pillar annular structure 3.

In some embodiments of the present disclosure, referring to FIG. 1, the vehicle 100 further includes a middle floor lower cross beam 4, a left rear longitudinal beam 411, and a right rear longitudinal beam 412. The left rear longitudinal beam 411 and the right rear longitudinal beam 412 are arranged spaced apart in the width direction of the vehicle 100. Two ends of the middle floor lower cross beam 4 are respectively connected with the left rear longitudinal beam 411 and the right rear longitudinal beam 412. Two ends of the rear floor upper cross beam 33 are respectively connected with the left rear longitudinal beam 411 and the right rear longitudinal beam 412.

The left rear longitudinal beam 411 and the right rear longitudinal beam 412 are connected at a front end of the vehicle by the middle floor lower cross beam 4 and connected at a rear end of the vehicle by the rear floor upper cross beam 33, thereby forming a closed second C-pillar annular structure, which improves the structural strength of the vehicle 100 in the position, facilitates the overall structural strength of the vehicle 100, and then can effectively improve the torsional stiffness of the vehicle 100 and improve the torsional resistance while enhancing the strength of the first C-pillar annular structure 3.

In some embodiments of the present disclosure, referring to FIG. 7, a rear end 162 of the battery pack is connected with the middle floor lower cross beam 4, so that the battery pack 16, a front section of the left rear longitudinal beam 411, the rear floor upper cross beam 33, and a front section of the right rear longitudinal beam 412 form a closed third C-pillar annular structure, which improves the connection strength between the battery pack 16 and the vehicle 100, improves the structural strength of the vehicle 100 in the position, and facilitates the overall structural strength of the vehicle 100. In addition, the first C-pillar annular structure 3 can be further enhanced to improve the torsional strength of the vehicle 100.

In some embodiments of the present disclosure, referring to FIG. 6 and FIG. 7, the vehicle 100 further includes a rear floor 5. The rear floor upper cross beam 33 is connected with the rear floor 5. The left rear longitudinal beam 411 includes a left rear longitudinal beam sealing plate 51. The left rear longitudinal beam sealing plate 51 is connected with the middle floor lower cross beam 4 and the rear floor 5. The right rear longitudinal beam 412 includes a right rear longitudinal beam sealing plate 52. The right rear longitudinal beam sealing plate 52 is connected with the middle floor lower cross beam 4 and the rear floor 5. A fourth C-pillar annular structure is formed by connecting the middle floor lower cross beam 4 and the rear floor upper cross beam 33 respectively by the left rear longitudinal beam sealing plate 51 and the right rear longitudinal beam sealing plate 52. The fourth C-pillar annular structure is connected with the first C-pillar annular structure 3, which enhances the strength of the first C-pillar annular structure 3.

In some embodiments of the present disclosure, referring to FIG. 6 and FIG. 7, the vehicle 100 further includes a seat mounting cross beam 53. The seat mounting cross beam 53 is connected with the left rear longitudinal beam sealing plate 51 and the right rear longitudinal beam sealing plate 52. A fifth C-pillar annular structure may be formed by connecting the seat mounting cross beam 53 and the middle floor lower cross beam 4 by the left rear longitudinal beam sealing plate 51 and the right rear longitudinal beam sealing plate 52. The fifth C-pillar annular structure is connected with the first C-pillar annular structure 3, which enhances the strength of the first C-pillar annular structure 3.

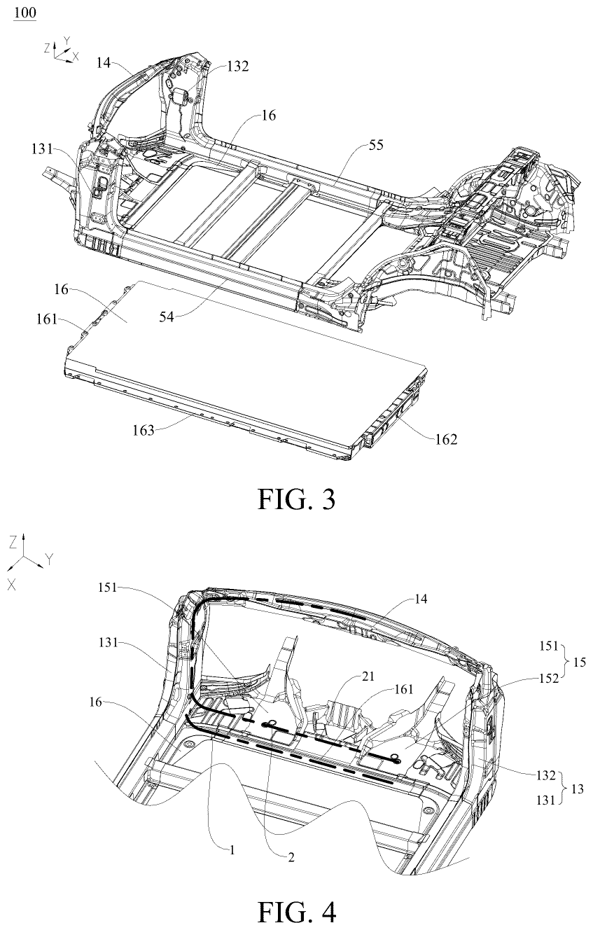

In some embodiments of the present disclosure, referring to FIG. 3, the vehicle 100 further includes a left sill beam 54 and a right sill beam 55. The left sill beam 54 and the right sill beam 55 are arranged spaced apart in the width direction of the vehicle 100. The left sill beam 54 is connected with the left A-pillar 131. The right sill beam 55 is connected with the right A-pillar 132. Two sides of the battery pack 16 are directly connected to the left sill beam 54 and the right sill beam 55 respectively.

The left sill beam 54 and the right sill beam 55 form mounting beams of the battery pack 16 respectively on two sides of the vehicle 100. The two sides of the battery pack 16 are respectively connected with the left sill beam 54 and the right sill beam 55. The left sill beam 54 is connected with the left A-pillar 131, and the right sill beam 55 is connected with the right A-pillar 132, to enable better involvement of the battery pack 16 in the first A-pillar annular force transmission structure 1, which can better enhance the strength of the first A-pillar annular force transmission structure 1, improve the torsional resistance, and improve the torsional strength of the vehicle 100.

In some embodiments of the present disclosure, the left front longitudinal beam 111 is connected with the left sill beam 54, and the right front longitudinal beam 112 is connected with the right sill beam 55. The left front longitudinal beam 111 is connected to the left sill beam 54, and the right front longitudinal beam 112 is connected to the right sill beam 55, thereby enhancing the strength of the first A-pillar annular force transmission structure 1, improving the torsional resistance, and improving the torsional strength of the vehicle 100.

In some embodiments of the present disclosure, referring to FIG. 6 and FIG. 7, the vehicle 100 further includes the middle floor lower cross beam 4. Two ends of the middle floor lower cross beam 4 are connected with the left sill beam 54 and the right sill beam 55 respectively. The rear end 162 of the battery pack is connected with the middle floor lower cross beam 4. The middle floor lower cross beam 4 and the dash board lower cross beam 21 are connected by the left sill beam 54, the right sill beam 55, the left front longitudinal beam 111, and the right front longitudinal beam 112, to form an overall annular force transmission structure. A battery mounting point is arranged on each of the left sill beam 54, the right sill beam 55, the left front longitudinal beam 111, the right front longitudinal beam 112, the middle floor lower cross beam 4, and the dash board lower cross beam 21. The battery pack 16 is connected to the overall annular force transmission structure through the battery mounting points, which can enhance the strength of the overall annular force transmission structure, thereby improving the torsional stiffness of the vehicle 100 and improving handling of the vehicle 100.

The left rear longitudinal beam is further connected to the left sill beam, and the right rear longitudinal beam is further connected to the right rear longitudinal beam, so that the left rear longitudinal beam and the right rear longitudinal beam can effectively enhance the strength of the overall annular force transmission structure and improve force transmission capability and the torsional resistance.

The front end 161 of the battery pack is connected with the battery mounting point on the dash board lower cross beam 21. The rear end 162 of the battery pack is connected with the battery mounting point on the middle floor lower cross beam 4. A left side 163 of the battery pack is connected with the battery mounting point on the left sill beam 54. A right side 164 of the battery pack is connected with the battery mounting point on the right sill beam 55, which can effectively reduce a weight of the vehicle, increase a ground clearance of the vehicle or increase space inside the vehicle, or reduce a vehicle height to improve the handling.

In some embodiments of the present disclosure, at least a part of an upper surface of the battery pack 16 is formed as a floor of the vehicle 100. The battery pack 16 is connected to a vehicle body through a battery connection plate, and a gap between the battery pack 16 and a vehicle body structure is sealed.

In the descriptions of the specification, a description with reference to a term such as “an embodiment”, “some embodiments”, “an example”, “a specific example”, or “some examples” means that features, structures, materials, or characteristics described with reference to the embodiment or the example are included in at least one embodiment or example of the present disclosure. In this specification, schematic descriptions of the foregoing terms are not necessarily directed at the same embodiment or example. Moreover, the features, structures, materials, or characteristics described may be combined in a proper manner in any one or more embodiments or examples. In addition, a person skilled in the art may integrate or combine different embodiments or examples described in the specification and features of the different embodiments or examples as long as they are not contradictory to each other.

Although the embodiments of the present disclosure have been shown and described above, it may be understood that the above embodiments are exemplary and cannot be construed as a limitation on the present disclosure. A person of ordinary skill in the art may make changes, modifications, replacements, or variations to the above embodiments within the scope of the present disclosure.

What is claimed is:

1. A vehicle, comprising:
a left front longitudinal beam and a right front longitudinal beam spaced apart in a width direction of the vehicle;
a left A-pillar and a right A-pillar spaced apart in the width direction of the vehicle, the left front longitudinal beam connected with a lower section of the left A-pillar, and the right front longitudinal beam connected with a lower section of the right A-pillar;
a windshield upper cross beam, two ends of the windshield upper cross beam respectively connected with an upper section of the left A-pillar and an upper section of the right A-pillar; and
a battery pack, a front end of the battery pack connected to the left front longitudinal beam and the right front longitudinal beam,
wherein the left front longitudinal beam, the right front longitudinal beam, the left A-pillar, the right A-pillar, the windshield upper cross beam, and the battery pack form a first A-pillar annular force transmission structure.

2. The vehicle according to claim 1, further comprising a dash board lower cross beam, wherein
the dash board lower cross beam is disposed between the left front longitudinal beam and the right front longitudinal beam, and is connected with the left front longitudinal beam and the right front longitudinal beam, and
the left front longitudinal beam, the right front longitudinal beam, the left A-pillar, the right A-pillar, the windshield upper cross beam, and the dash board lower cross beam form a second A- pillar annular force transmission structure.

3. The vehicle according to claim 2, wherein a projection of the battery pack in an up-down direction of the vehicle at least partially overlaps with a projection of the dash board lower cross beam in the up-down direction of the vehicle.

4. The vehicle according to claim 3, wherein the front end of the battery pack is connected to the dash board lower cross beam.

5. The vehicle according to claim 3, wherein:
a rear section of the left front longitudinal beam is connected with the left A-pillar and the dash board lower cross beam; and
a rear section of the right front longitudinal beam is connected with the right A-pillar and the dash board lower cross beam.

6. The vehicle according to claim 1, further comprising:
a rear floor upper cross beam;
a left shelf support plate and a right shelf support plate spaced apart in the width direction of the vehicle, and two ends of the rear floor upper cross beam respectively connected with a lower section of the left shelf support plate and a lower section of the right shelf support plate; and
a shelf connecting plate, two ends of the shelf connecting plate respectively connected with an upper section of the left shelf support plate and an upper section of the right shelf support plate,
wherein the rear floor upper cross beam, the left shelf support plate, the right shelf support plate, and the shelf connecting plate form a first C-pillar annular structure.

7. The vehicle according to claim 6, further comprising a left C-pillar and a right C-pillar, wherein the left shelf support plate is connected with the left C-pillar, and the right shelf support plate is connected with the right C-pillar.

8. The vehicle according to claim 7, further comprising:
a middle floor lower cross beam; and
a left rear longitudinal beam and a right rear longitudinal beam spaced apart in the width direction of the vehicle, two ends of the middle floor lower cross beam respectively connected with the left rear longitudinal beam and the right rear longitudinal beam, and the two ends of the rear floor upper cross beam respectively connected with the left rear longitudinal beam and the right rear longitudinal beam.

9. The vehicle according to claim 8, wherein a rear end of the battery pack is connected with the middle floor lower cross beam.

10. The vehicle according to claim 9, further comprising:
a rear floor connected with the rear floor upper cross beam, wherein
the left rear longitudinal beam comprises a left rear longitudinal beam sealing plate that is connected with the middle floor lower cross beam and the rear floor, and
the right rear longitudinal beam comprises a right rear longitudinal beam sealing plate that is connected with the middle floor lower cross beam and the rear floor.

11. The vehicle according to claim 10, further comprising:
a seat mounting cross beam connected with the left rear longitudinal beam sealing plate and the right rear longitudinal beam sealing plate.

12. The vehicle according to claim 4, further comprising:
a left sill beam and a right sill beam spaced apart in the width direction of the vehicle, the left sill beam connected with the left A-pillar, the right sill beam connected with the right A-pillar, and two sides of the battery pack connected to the left sill beam and the right sill beam respectively.

13. The vehicle according to claim 12, wherein the left front longitudinal beam is connected with the left sill beam; and the right front longitudinal beam is connected with the right sill beam.

14. The vehicle according to claim 12, further comprising:
a middle floor lower cross beam, two ends of the middle floor lower cross beam connected with the left sill beam and the right sill beam,
wherein a rear end of the battery pack is connected with the middle floor lower cross beam.

15. The vehicle according to claim 14, wherein at least a part of an upper surface of the battery pack is formed as a vehicle floor.
